(19) United States
(12) Patent Application Publication
(10) Pub. No.: US 2018/0059806 A1
(43) Pub. Date: Mar. 1, 2018

(54) INFORMATION PROCESSING DEVICE, INPUT CONTROL METHOD FOR CONTROLLING INPUT TO INFORMATION PROCESSING DEVICE, AND COMPUTER-READABLE STORAGE MEDIUM STORING PROGRAM FOR CAUSING INFORMATION PROCESSING DEVICE TO PERFORM INPUT CONTROL METHOD

(71) Applicant: Panasonic Intellectual Property Management Co., Ltd., Osaka (JP)

(72) Inventor: KEN MORI, Osaka (JP)

(21) Appl. No.: 15/789,470

(22) Filed: Oct. 20, 2017

Related U.S. Application Data
(63) Continuation of application No. PCT/JP2016/000998, filed on Feb. 25, 2016.

(30) Foreign Application Priority Data
Jun. 24, 2015 (JP) 2015-126980

(51) Int. Cl. G06F 3/038; G06F 3/0488; G06F 3/0354; G06F 3/03

(52) U.S. Cl. CPC G06F 3/038; G06F 3/04886; G06F 3/0416; G06F 3/0317; G06F 3/03545

(57) ABSTRACT

An information processing device includes: a display unit that displays information; a first detector that detects one of contact and proximity of the position indicator with respect to the display unit; a second detector that detects an operation of the operation key by a user; and a controller that issues an event for the operation key the operation of which has been detected by the second detector. The controller does not issue the event for the operation key in cases where none of the contact and the proximity of the position indicator has been detected when the second detector detects the operation of the operation key, and subsequently, when one of the contact and the proximity of the position indicator is detected, the controller issues the event for the operation key.

### BACKGROUND

### Technical Field

The present disclosure relates to an information processing device on which information input using a position indicator and an operation key is possible, an input control method for controlling an input to the information processing device, and a program for causing the information processing device to perform the input control method.

### Background Art

There is an information processing device on which information input, an operation, etc., are possible by using a combination of a pen and the touch of a finger. For example, patent literature (PTL) 1 discloses an input device including: pen coordinate input means that inputs a gesture, the coordinates of a position, or the like with a pen; and second coordinate input means that inputs the coordinates of a position with the touch of a finger. When a position is input with the touch of a finger via the second coordinate input means, this input device determines, as an input event, the position and a gesture that has been input with the pen via the pen coordinate input means. When no position is input via the second coordinate input means, a position and ae gesture input that have been input via the pen coordinate input means are determined as an input event. This allows a user to use the device differently at will, for example, by inputting a position via the second coordinate input means with a finger on his or her left hand and inputting a gesture via the pen coordinate input means with a pen held in his or her right hand or by inputting both a gesture and a position only via the pen coordinate input means with a pen held in his or her right hand.

### CITATION LIST

### Patent Literature

PTL 1: Unexamined Japanese Patent Publication No. 1106-083524

### SUMMARY

In a first aspect of the present disclosure, an information processing device on which information input using a position indicator and an operation key is possible is provided. The information processing device includes: a display unit that displays information; a first detector that detects one of contact and proximity of the position indicator with respect to the display unit; a second detector that detects an operation of the operation key by a user; and a controller that issues an event for the operation key the operation of which has been detected by the second detector. The controller does not issue the event for the operation key in cases where none of the contact and the proximity of the position indicator has been detected when the second detector detects the operation of the operation key, and subsequently, when one of the contact and the proximity of the position indicator is detected, the controller issues the event for the operation key.

In a second aspect of the present disclosure, an input control method for controlling an input to an information processing device using a position indicator and an operation key is provided. The input control method includes: detecting one of contact and proximity of the position indicator with respect to a display unit of the information processing device; detecting an operation of the operation key by a user; and issuing an event for the operation key the operation of which has been detected. In the issuing of the event, the event for the operation key is not issued in cases where none of the contact and the proximity of the position indicator has been detected when the operation of the operation key is detected, and subsequently, when one of the contact and the proximity of the position indicator is detected, the event for the operation key is issued.

According to the present disclosure, it is possible to provide an information processing device on which a position indicator and an operation key can perform input operations in combination without a user feeling a sense of discomfort.

### BRIEF DESCRIPTION OF THE DRAWINGS

FIG. 1A is a plan view of an information processing device according to an exemplary embodiment.

FIG. 1B illustrates a configuration of an information processing device according to an exemplary embodiment.

FIG. 2 illustrates a configuration of an electronic pen according to an exemplary embodiment.

FIG. 3A illustrates a display example of on-screen keys displayed on an information processing device.

FIG. 3B illustrates another display example of on-screen keys displayed on an information processing device.

FIG. 4 illustrates the relationship among an operating system (OS), a key input utility, and an application.

FIG. 5A illustrate an example of a drag operation using both on-screen keys and pen-based input.

FIG. 5B illustrate an example of a drag operation using both on-screen keys and pen-based input.

FIG. 6 illustrates a problem with a drag operation using both on-screen keys and pen-based input.

FIG. 7 is a flowchart illustrating a process of a key input utility in an information processing device.

FIG. 8 illustrates an operation of an information processing device when an on-screen key is pressed down.

### DETAILED DESCRIPTION

Hereinafter, exemplary embodiments will be described in detail with reference to the drawings as necessary. However, there are instances where overly detailed description is omitted. For example, detailed description of well-known matter, overlapping description of substantially identical elements, etc., may be omitted. This is to prevent the subsequent description from becoming unnecessarily redundant, and thus facilitate understanding by a person having ordinary skill in the art. Note that the accompanying drawings and the subsequent description are provided so that a person having ordinary skill in the art is able to sufficiently understand the present disclosure, and are not intended to limit the scope of the subject matter recited in the claims.

### First Exemplary Embodiment

The information processing device in the exemplary embodiment described below is an electronic device on which information input and an operation are possible with the touch of one or both of a user's finger and an electronic pen on a display screen. Examples of such an electronic device may include a smartphone, a tablet device, a laptop personal computer, and an electronic whiteboard. An information processing device according to the first exemplary embodiment is described below with reference to the accompanying drawings.

[1-1. Configuration]

[1-1-1. Configuration of Information Processing Device]

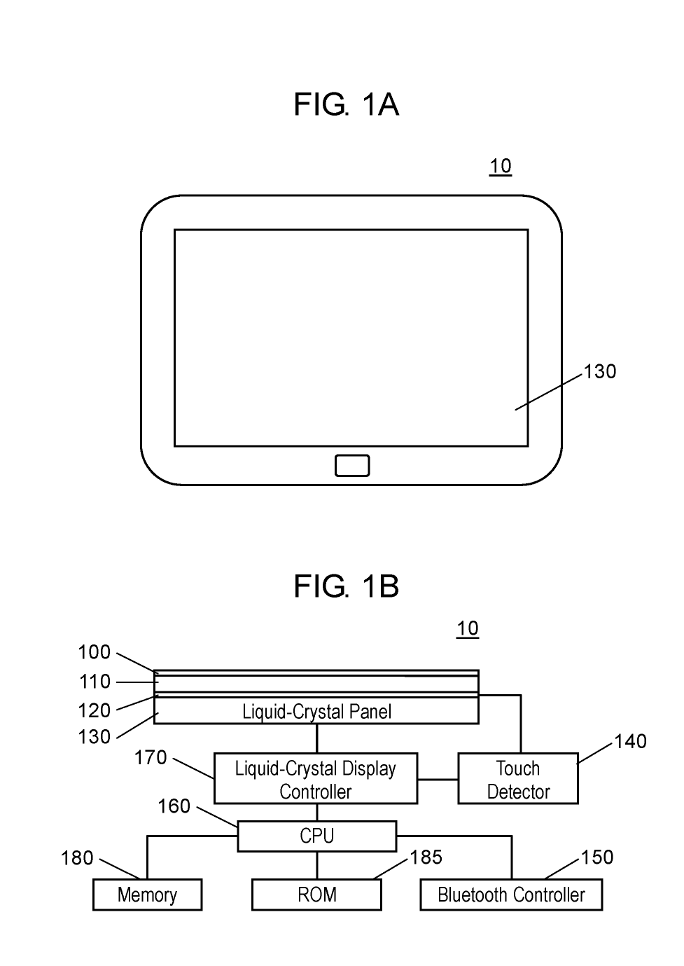

FIG. 1A is a plan view of the information processing device according to the present exemplary embodiment. As illustrated in FIG. 1A, information processing device 10 is configured as a tablet device an example in the present exemplary embodiment. FIG. 1B illustrates a configuration of information processing device 10 according to the present exemplary embodiment. As illustrated in FIG. 1B, information processing device 10 includes film 100 with a dot pattern, cover glass 110, sensor 120 for touch detection, liquid-crystal panel 130, touch detector 140, Bluetooth controller (in which “Bluetooth” is a registered trademark and which is hereinafter referred to as “controller”) 150, central processing unit (CPU) 160, liquid-crystal display controller 170, memory 180, and read only memory (ROM) 185.

Film 100 with the dot pattern is a film on which dots are mounted in a specific arrangement so that an image processing unit (to be described later) of the electronic pen can identify an image position from the dot pattern within a predetermined range. Cover glass 110 is for protecting liquid-crystal panel 130, sensor 120 for touch detection, etc. Sensor 120 for touch detection includes, for example, transparent electrodes arranged in a grid and a detection circuit, and monitors the transparent electrodes for a change in voltage to detect contact of a finger or the like with the display screen of liquid-crystal panel 130.

Liquid-crystal panel 130 displays a display pattern determined by liquid-crystal display controller 170. According to the display pattern, liquid-crystal panel 130 displays video, images such as a variety of icons, and a variety of information such as text provided by an application.

Touch detector 140 is, for example, a circuit that controls the voltage at sensor 120 for touch detection on liquid-crystal panel 130 and monitors the voltage for a change or the like to detect contact of a finger, a stylus pen, or the like with liquid-crystal panel 130 and generates information (coordinate data) about a contact position on liquid-crystal panel 130. Note that touch detector 140 does not detect contact of the electronic pen according to the present exemplary embodiment with liquid-crystal panel 130. In other words, a user can input information (coordinate data) to the information processing device by touching liquid-crystal panel 130 with a finger, a stylus pen, or the like.

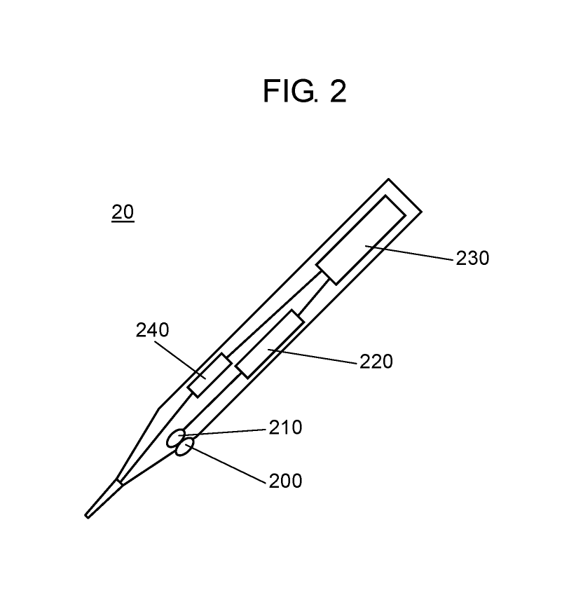

Controller 150 receives data including position information about contact or proximity of the electronic pen, contact information from a pen pressure sensor (to be described later), etc., transmitted from Bluetooth controller (in which “Bluetooth” is a registered trademark and which is hereinafter referred to as “controller”) 230 (refer to FIG. 2, which is to be described later) of the electronic pen, and transfers the data to CPU 160.

CPU 160 reads and executes a program stored in ROM 185 and controls the entire operation of information processing device 10. CPU 160 obtains touch position information from touch detector 140 and obtains position information about contact or proximity of the electronic pen from controller 150. Furthermore, CPU 160 reports the trajectory of the electronic pen based on the obtained contact positions to liquid-crystal display controller 170 so that the trajectory is displayed on liquid-crystal panel 130. In addition, CPU 160 detects a gesture operation such as tapping, flicking, pinching in, or pinching out in a touch operation with a user's finger, etc., on the basis of a detection signal from touch detector 140, and performs display control based on the gesture operation.

Liquid-crystal display controller 170 generates a display pattern reported from CPU 160 and displays the display pattern on liquid-crystal panel 130. Liquid-crystal display controller 170 displays, on liquid-crystal panel 130, the trajectory of the electronic pen based on the contact positions obtained by CPU 160.

Memory 180 and ROM 185 are configured as semiconductor memory elements. A program to be executed by CPU 160 is stored in ROM 185. Memory 180 can be configured as dynamic random access memory (DRM), static random access memory (SRAM), flash memory, or the like.

[1-1-2. Configuration of Electronic Pen]

FIG. 2 illustrates a configuration of the electronic pen for inputting information to information processing device 10.

In FIG. 2, electronic pen 20 includes light emitting diode (LED) 200, image sensor (camera) 210, image processing unit 220, controller 230, and pen pressure sensor 240.

LED 200 emits light. On the basis of reflected light originating from the light emitted from LED 200, image sensor 210 reads the dot pattern of film 100 located at the tip of electronic pen 20 coming into contact with film 100 with the dot pattern, and transfers image data including the read pattern to image processing unit 220. Note that as long as electronic pen 20 is in close proximity to film 100 with the dot pattern, image sensor 210 can read the dot pattern located at the tip of electronic pen 20 even when electronic pen 20 is not in contact with film 100 with the dot pattern.

Image processing unit 220 analyzes the image data (the dot pattern) obtained from image sensor 210, generates position information (coordinate data) about the contact position of the tip of the pen, and transfers the position information to controller 230. When electronic pen 20 is not in contact with, but in close proximity to film 100 with the dot pattern and furthermore is held tilted against film 100 with the dot pattern, image sensor 210 reads the dot pattern offset from a position located vertically below the tip of electronic pen 20 with respect to film 100 with the dot pattern. When electronic pen 20 is held tilted without contacting film 100 with the dot pattern, the dot pattern obtained by image sensor 210 changes in shape according to the slope of electronic pen 20. Therefore, image processing unit 220 calculates the slope of electronic pen 20 from a change in the shape thereof and performs position correction according to the slope. This makes it possible to generate position information about the position located vertically below the tip of electronic pen 20 with respect to film 100 with the dot pattern.

Controller 230 of electronic pen 20 transmits the position information transferred from image processing unit 220 and the contact information transferred from pen pressure sensor 240 to controller 150 of information processing device 10.

Pen pressure sensor 240 detects whether or not the tip of electronic pen 20 is in contact with other objects, and transfers contact information indicating the result of the detection to controller 230 of electronic pen 20.

[1-2. Operations]

[1-2-1. Touch Input Using Finger]

As described above, when a user's finger is brought into contact with the screen of liquid-crystal panel 130, touch detector 140 detects the contact and generates the contact position information (the coordinate data). In this way, a user can input information to information processing device 10 by performing a touch operation on the screen of liquid-crystal panel 130 with a finger. Note that a stylus pen may be used instead of a user's finger.

[1-2-2. Input Using Electronic Pen]

An input operation of electronic pen 20 performed on information processing device 10 will be described.

Electronic pen 20 causes image sensor 210 to capture an image of a subject located at the tip of the pen and generate image data. Image processing unit 220 analyzes a dot pattern from the image data generated by image sensor 210 and generates position information (coordinate data) about the contact position at the tip of the pen.

When the dot pattern cannot be obtained because electronic pen 20 is not in contact with or in close proximity to film 100 with the dot pattern, image processing unit 220 does not generate the position information. In contrast, when electronic pen 20 is in contact with or in close proximity to film 100 with the dot pattern, image processing unit 220 can analyze the dot pattern from the image data. In this case, image processing unit 220 generates the position information and transfers the position information to controller 230.

When controller 230 obtains the position information from image processing unit 220, controller 230 determines whether or not contact information has been reported from pen pressure sensor 240.

When electronic pen 20 is in contact with a surface of information processing device 10, pen pressure sensor 240 reports the contact information to controller 230, and controller 230 transmits the contact information and the position information to controller 150 of information processing device 10.

When electronic pen 20 is not in contact with the surface of information processing device 10, that is, when the contact information has not been reported from pen pressure sensor 240, controller 230 transmits only the position information to information processing device 10 (controller 150).

CPU 160 of information processing device 10 receives the position information and the contact information from electronic pen 20 by controller 150, and identifies, on the basis of the received information, the position on liquid-crystal panel 130 where the information was input by electronic pen 20.

In the way described above, information input, an operation, etc., using a finger, electronic pen 20, or the like are possible on information processing device 10 according to the present exemplary embodiment.

[1-2-3. On-Screen Keys]

Information processing device 10 according to the present exemplary embodiment has a function for displaying a virtual operation button (hereinafter referred to as “on-screen key”) on liquid-crystal panel 130 and receiving an input from a user operating the on-screen key. This function is realized by a key input utility which is executed on CPU 160. Specifically, the key input utility is software that realizes a function for displaying an on-screen key on liquid-crystal panel 130 and detecting an input from a user operating the on-screen key.

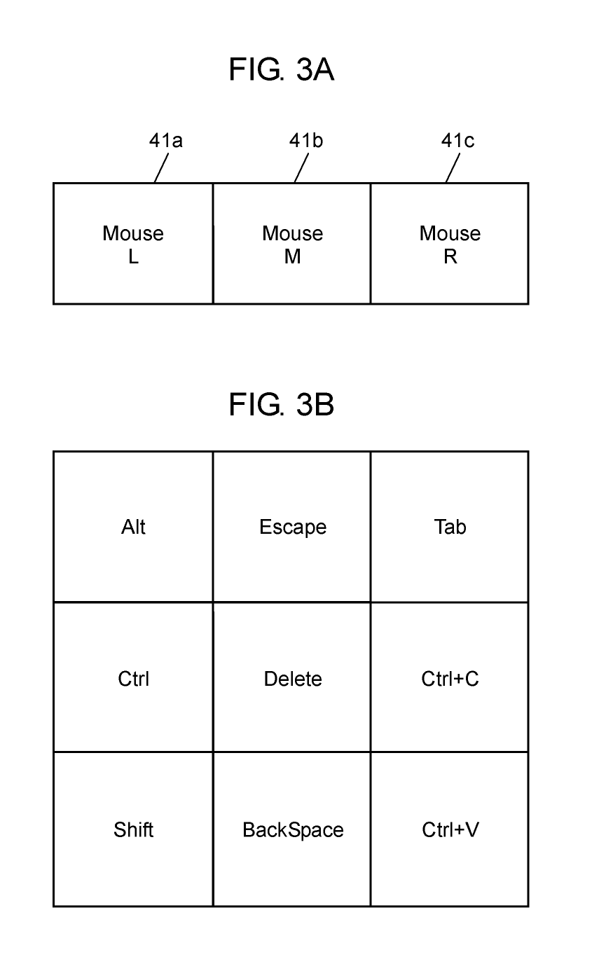

FIG. 3A and FIG. 3B illustrate examples of a keypad displayed by the key input utility on liquid-crystal panel 130. The keypad illustrated in FIG. 3A includes, as the on-screen key, on-screen keys 41a, 41b, and 41c respectively corresponding to the left click button, the middle button, and the right click button of a mouse. FIG. 3B illustrates an example of another keypad displayed on liquid-crystal panel 130. The keypad illustrated in FIG. 3B includes keys such as “Alt”, “Escape”, and “Ctrl”, and keys corresponding to shortcut keys, such as “Ctrl+C”, which are a combination of a plurality of keys.

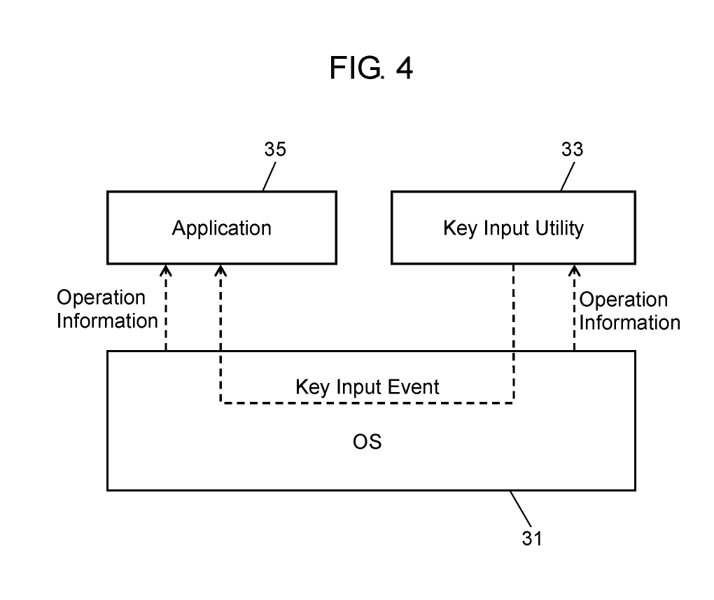

FIG. 4 illustrates the relationship among the key input utility, an operating system (OS), and an application which are realized in a functional manner by CPU 160 of information processing device 10.

OS 31 reports the contact position (the operation position) of a finger, electronic pen 20, or the like detected by touch detector 140, controller 150, etc., to application 35, key input utility 33, etc.

When key input utility 33 detects on the basis of the report from OS 31 that a user has pressed down (operated) the on-screen key displayed on liquid-crystal panel 130, key input utility 33 issues an event indicating the pressed (operated) on-screen key. This event is reported to application 35 via OS 31. On the basis of the reported event, application 35 identifies the type of the pressed button and performs a process according to the pressed button.

For example, when on-screen key (right-click mouse button) 41c corresponding to the right click button of a mouse is pressed down, the key input utility issues an event indicating the right click button of the mouse. Application 35 receives this event via OS 31 and recognizes that the right click button of the mouse has been operated, and performs a process predetermined for when the right click button of the mouse is operated.

Application 35 performs the predetermined process according to the operation key indicated by the event reported from OS 31.

Information processing device 10 can detect an operation of the on-screen key displayed on liquid-crystal panel 130 and an operation using electronic pen 20 at the same time. Performing an operation by using the on-screen key and electronic pen 20 in combination can substitute a mouse operation. Examples of the function realized by the operation using the on-screen key and the electronic pen in combination are indicated in [Example 1] to [Example 3] below.

### Example 1

An operation including a combination of pressing down a “MOUSE M” on-screen key and moving the electronic pen moves (drags) an object.

### Example 2

An operation including a combination of simultaneously pressing down the “MOUSE M” on-screen key and a “MOUSE R” on-screen key and moving the electronic pen rotates an object.

### Example 3

An operation including a combination of simultaneously pressing down the “MOUSE M” on-screen key and the “MOUSE R” on-screen key, followed by releasing the “MOUSE R” on-screen key, and moving the electronic pen expands or contracts an object.

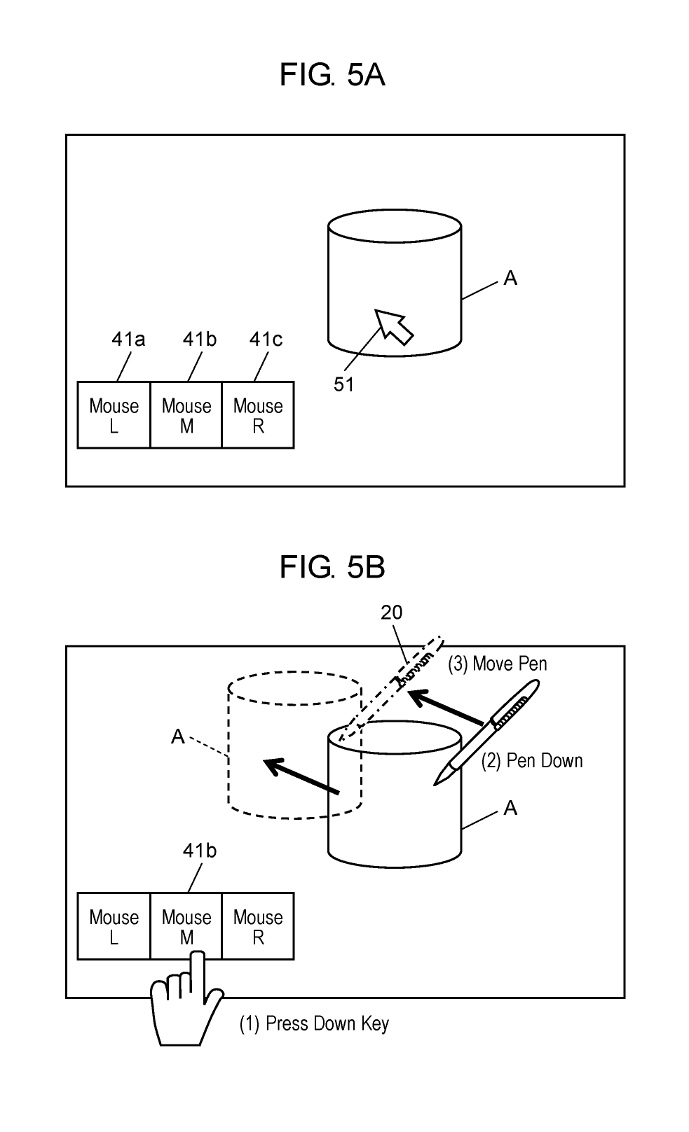

An operation (a drag operation) for moving an object displayed on liquid-crystal panel 130 by using the on-screen key and electronic pen 20 will be described with reference to FIG. 5A and FIG. 5B. A description is given of the operation for moving object A when on-screen keys 41a to 41c and object A are displayed on liquid-crystal panel 130, as illustrated in FIG. 5A. A user designates object A, which is to be moved, by using the electronic pen or the like and then touches on-screen key (“MOUSE M”) 41b first with a finger on his or her one hand (refer to FIG. 5B). Next, the user touches the screen with electronic pen 20 held in the other hand while the finger on his or her one hand is kept in contact with on-screen key (“MOUSE M”) 41b. Subsequently, the user moves electronic pen 20 in a direction in which object A is desired to move while electronic pen 20 is kept in contact with the screen. Such an operation causes object A to move a distance equal to the distance electronic pen 20 has moved, in the direction corresponding to the movement of electronic pen 20.

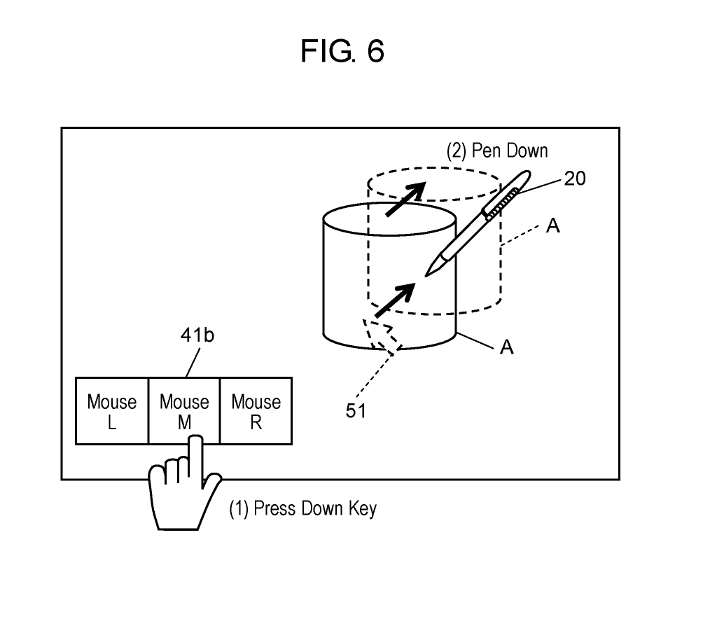

When such a series of operations as described above are performed, however, the following problem conventionally occurs. Specifically, there is the problem that object A moves instantly when the user touches the screen with electronic pen 20 after pressing down on-screen key (“MOUSE M”) 41b in the series of operations. FIG. 6 illustrates a problem with a drag operation using both on-screen keys and pen-based input.

As a result of diligent examination by the inventor on this problem, the cause thereof was found to be due to the event which indicates the operation of on-screen key (“MOUSE M”) 41b being issued at a point in time when a user presses down on-screen key (“MOUSE M”) 41b first. Specifically, when on-screen key (“MOUSE M”) 41b is pressed down, the event is issued which indicates that the on-screen key, that is, the middle button of the mouse, has been pressed down. The application for displaying object A enters into a “drag mode” of performing an operation for moving the object according to the movement of the cursor when receiving the event indicating that the middle button of the mouse has been pressed down. Therefore, when electronic pen 20 comes into contact with the screen, the application has already been in the drag mode and thus causes the object to move toward the contact position of electronic pen 20 (that is, a new cursor position) according to the operation in the drag mode. In this case, the starting point of the movement is the position of cursor 51 located when on-screen key (“MOUSE M”) 41b is pressed down. This position of cursor 51 is usually different from the contact position of electronic pen 20, leading to the phenomenon in which the object moves according to the operation of electronic pen 20 coming into contact with the screen.

Thus, the inventor devised the idea of not issuing the event for the on-screen key if electronic pen 20 is not in contact with the screen at a point in time when the on-screen key is pressed down first, but issuing later the event for the earlier operation of the on-screen key when contact of electronic pen 20 with the screen is detected. Accordingly, it is not until electronic pen 20 comes into contact with the screen that the fact that the on-screen key has been operated is transmitted to the application, meaning that the process corresponding to the on-screen key starts from a point in time when contact of electronic pen 20 is detected. Therefore, it is possible to prevent unnatural movement of the object and allow a user to perform an operation without feeling a sense of discomfort.

[1-2-4. Operation of Key Input Utility]

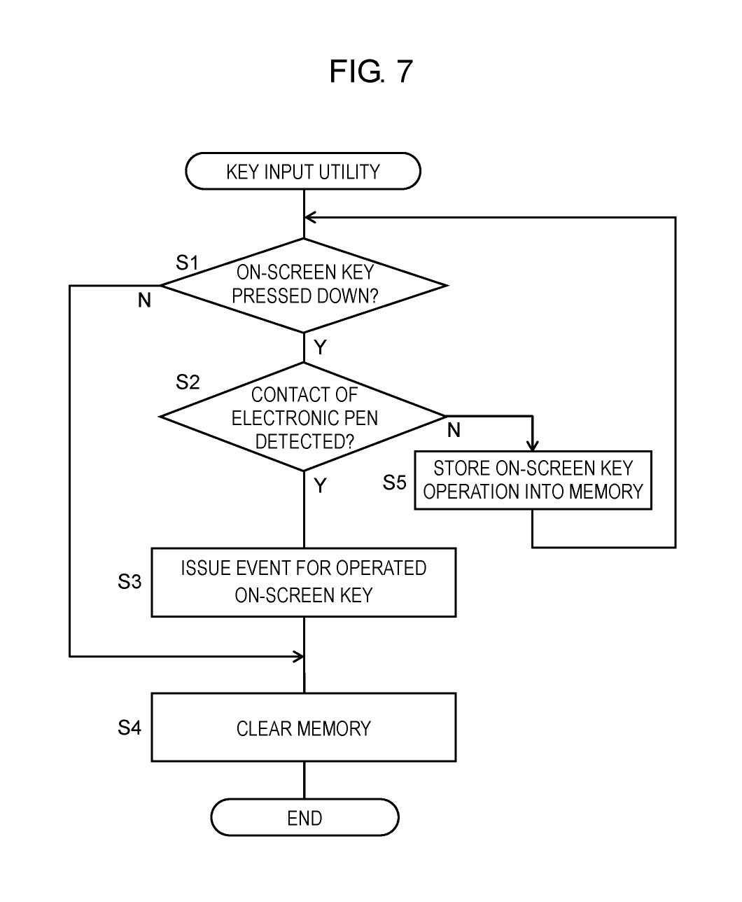

FIG. 7 is a flowchart illustrating a process of the key input utility in the information processing device. A function of key input utility 33 will be described with reference to the flowchart in FIG. 7. The function of the key input utility is realized by CPU 160 of information processing device 10 executing a predetermined program. The process illustrated in FIG. 7 is performed in a predetermined cycle while the key input utility is running effectively.

Key input utility 33 (CPU 160) determines whether or not the on-screen key has been pressed down (S1). When key input utility 33 detects a touch operation of a user's finger performed on the screen, key input utility 33 can determine on the basis of the contact position whether or not the on-screen key has been pressed down. When the on-screen key has not been pressed down (N in Step S1), memory 180 is cleared, and the present process is ended.

When the on-screen key has been pressed down (Y in Step S1), key input utility 33 determines whether or not an operation using electronic pen 20 has been performed on the screen (S2). Specifically, key input utility 33 determines whether or not electronic pen 20 is in contact with the screen.

When contact of electronic pen 20 with the screen has been detected (Y in Step S2), key input utility 33 issues, to OS 31, an input event indicating a key corresponding to the operated on-screen key (S3).

In contrast, when contact of electronic pen 20 (that is, an operation using electronic pen 20) has not been detected when the on-screen key is pressed down (N in Step S2), key input utility 33 stores information about the operation of the pressed on-screen key (information indicating the type of the operated key, the operation, and the like) into memory 180 (S5), and the processing returns to Step S1. Here, if the type of the on-screen key operated this time and the content of the operation are the same as those of the last operation, key input utility 33 does not store the information about the operation of the on-screen key operated this time into memory 180. When at least one of the type of the on-screen key operated this time and the content of the operation is different from those of the last operation, key input utility 33 additionally stores, in to the memory, the information about the operation of the on-screen key operated this time while the information already stored in memory 180 is held. In this way, the information about the operation of the on-screen key, newly generated in the period between when the on-screen key is pressed down once and when contact of electronic pen 20 (an operation using electronic pen 20) is detected, is stored into memory 180.

Subsequently, when contact of electronic pen 20 is detected (Y in S2), key input utility 33 issues, to OS 31, an event about the operation of every on-screen key stored in memory 180 (S3).

The issued event is reported to the running application via the function of OS 31, and the application performs the process corresponding to the operation key indicated in the reported event.

Memory 180 is cleared (S4) after the issuance of the event.

As described above, in the present exemplary embodiment, even in cases where a user operates the on-screen key, the event indicating the operation of the on-screen key is not issued when contact of electronic pen 20 with the screen (an operation using electronic pen 20) is not detected at the same time. Subsequently, when contact (an operation) of electronic pen 20 is detected, the event about the earlier operation of the on-screen key is issued. Such control allows the application to start the process corresponding to the on-screen key from the position in which a user performs a touch operation first by using the electronic pen so that the process corresponding to the on-screen key is carried out without giving the user a sense of discomfort.

In the period between when one on-screen key operation is performed and when a touch operation using electronic pen 20 is detected, if another on-screen key operation is performed, these plural on-screen key operations will be stored. Subsequently, when a touch operation using electronic pen 20 is performed, the events for the plurality of on-screen key operations are collectively issued. For expanding or contracting an object, for example, on-screen keys 41b and 41c corresponding to the middle button and the right click button of the mouse are pressed down at the same time first, then an operation for releasing pressed on-screen key 41c corresponding to the right click button of the mouse is performed, and in this state, a touch operation of electronic pen 20 is performed. In cases where such operations are performed, when the operation of electronic pen 20 is detected, an input event indicating the simultaneous operations of pressing down the middle button and the right click button of the mouse and an input event indicating the subsequent operation of releasing the right click button of the mouse are issued in sequence. This allows a combination of the plurality of operations of the on-screen keys to be reported to the application.

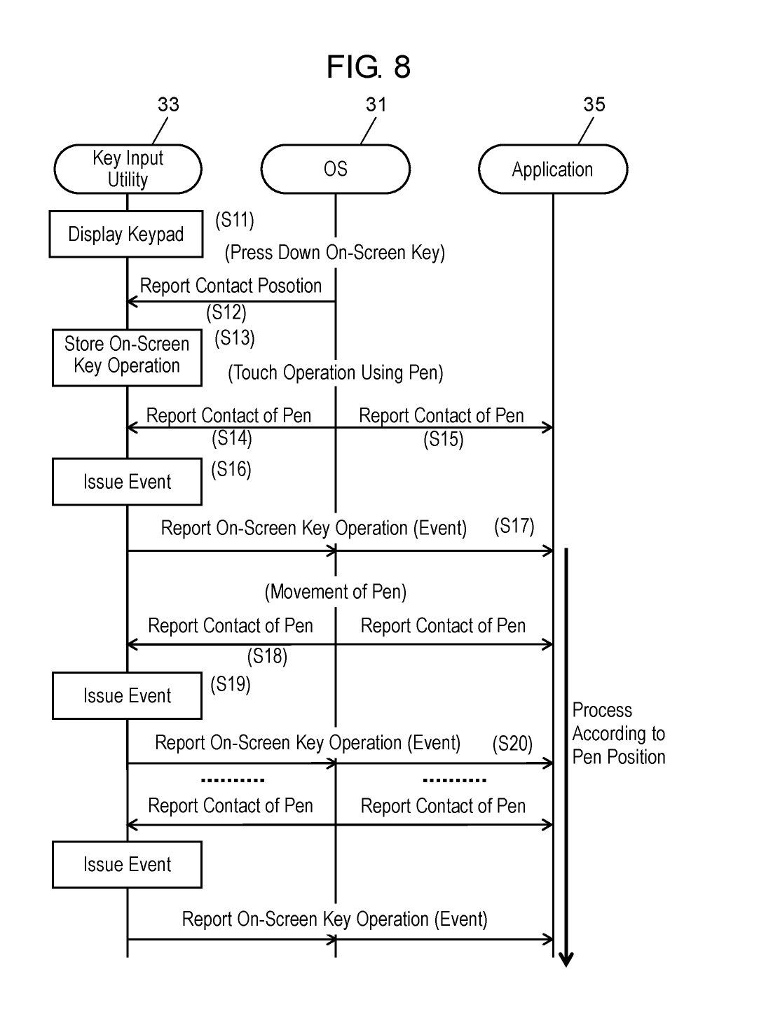

FIG. 8 specifically illustrates one example of operation information exchange among OS31, key input utility 33, and application 35 when the on-screen key and electronic pen 20 perform input operations.

When key input utility 33 is running, a keypad including the on-screen keys such as those illustrated in FIG. 3A or FIG. 3B is displayed on liquid-crystal panel 130 (S11). In this state, when the on-screen key is pressed down (operated) with a user's finger, OS 31 reports information indicating the contact position of the finger to key input utility 33 (S12). On the basis of the contact position information, key input utility 33 determines whether or not the on-screen key has been pressed down. In the example in FIG. 8, key input utility 33 determines that the on-screen key has been pressed down, but, since contact of electronic pen 20 has not been detected, key input utility 33 does not immediately issue an event about pressing down of the on-screen key, stores information about the operated on-screen key into memory 180 (S13), and waits for contact of electronic pen 20 (an operation of electronic pen 20) to be detected.

Subsequently, when the user performs a touch operation on the screen by using electronic pen 20, OS 31 reports information about the contact of electronic pen 20 (contact information and position information) to key input utility 33 and application 35 (S14, S15).

When key input utility 33 receives the information about the contact of electronic pen 20, key input utility 33 issues an event about the operation of the on-screen key stored in memory 180 (S16). Accordingly, a report to the effect that the key corresponding to the on-screen key has been operated is provided to application 35 via OS 31 (S17). Application 35 performs a predetermined process on the basis of the reported key and the contact position of electronic pen 20.

Subsequently, when electronic pen 20 moves on the screen while the on-screen key is held pressed, OS 31 continuously reports the contact of the electronic pen to key input utility 33. In this case, at the same time, key input utility 33 receives information indicating the contact position of a finger from OS 31, and continues recognizing pressing down of the on-screen key on the basis of the information. Since the contact of electronic pen 20 has been detected when pressing down of the on-screen key is detected, key input utility 33 instantaneously issues an event corresponding to the on-screen key (S19, S20). Application 35 performs a predetermined process on the basis of the reported information indicating the button and the touch position of electronic pen 20.

[1-3. Effects Etc.]

As described above, information processing device 10 according to the present exemplary embodiment includes: liquid-crystal panel 130 (one example of the display unit) that displays information; controller 150 (one example of the first detector) that detects one of contact and proximity of electronic pen 20 (one example of the position indicator) with respect to liquid-crystal panel 130; touch detector 140 (one example of the second detector) and key input utility 33 that detect an operation by a user of the on-screen key (one example of the operation key); and CPU 160 that issues an event indicating the type of the on-screen key the operation of which has been detected by touch detector 140 and key input utility 33. CPU 160 does not issue an event for the on-screen key in cases where contact (or proximity) of electronic pen 20 has not been detected when an operation of the on-screen key is detected, and subsequently, when contact (or proximity) of electronic pen 20 is detected, CPU 160 issues the event for the on-screen key (Steps S2 and S3 in FIG. 7).

According to the above configuration, even in cases where a user operates the on-screen key, the event indicating the operation of the on-screen key is not issued when contact of electronic pen 20 with the screen (an operation using electronic pen 20) is not detected at the same time. Subsequently, when contact (an operation) of electronic pen 20 is detected, the event about the earlier operation of the on-screen key is issued. Such control allows the application to start the process corresponding to the on-screen key from the position in which a user performs a touch operation first by using the electronic pen so that the process corresponding to the on-screen key is carried out without giving the user a sense of discomfort.

### Other Exemplary Embodiments

The first exemplary embodiment has been described above as an exemplification of techniques disclosed in the present application. The techniques according to the present disclosure, however, are not limited to the foregoing exemplary embodiment, and can also be applied to exemplary embodiments obtained by carrying out modification, substitution, addition, omission, etc., as necessary. Furthermore, it is also possible to obtain a new embodiment by combining respective structural elements described in the above first exemplary embodiment. Examples of other embodiments include the following.

Liquid-crystal panel 130 has been described as one example of the display unit in the above first exemplary embodiment. The display unit may be any unit as long as it displays information. Therefore, the display unit is not limited to liquid-crystal panel 130. Note that in the case of using liquid-crystal panel 130 as the display unit, panels of a variety of sizes can be obtained at low cost. An organic electro-luminescent (EL) panel, a plasma panel, or the like may be used as the display unit.

In the above first exemplary embodiment, as one example of a touch position detector, touch detector 140 has been described which controls the voltage at sensor 120 for touch detection on liquid-crystal panel 130 and monitors the voltage for a change or the like to detect touching of a finger or the like. The touch position detector may be any unit as long as it detects a position on the display unit where a user touched. Therefore, the touch position detector is not limited to that using the above-described method. As the method of detecting the touch position on the display unit, it may be possible to use a surface acoustic wave method in which a piezoelectric element is attached to generate oscillatory waves, an infrared method of detecting a position by blocking infrared light, or a capacitance method of detecting a position by sensing a change in the capacitance of a fingertip.

The method using an electronic pen as one example of the position indicator has been described in the above first exemplary embodiment. The position indicator, however, does not limited to the electronic pen and may be any unit as long as it can indicate a position (coordinates) on the display unit when contact or proximity thereof with respect to the display unit is detected by the first detector. Examples of the position indicator, other than the electronic pen, include a user's finger or hand and a pointing device such as a capacitance touch pen. In the case of using a user's finger or a capacitance touch pen as the position indicator, a sensor that detects capacitance between the position indicator and the display unit can be used as the first detector.

The above first exemplary embodiment has described, as one example of the electronic pen, a method in which image sensor 210 is used to read a dot pattern from film 100 with the dot pattern on which dots are mounted in a specific arrangement so that an image position can be identified from the dot pattern within a predetermined range, and the read dot pattern is analyzed to generate position information (coordinate data). The electronic pen may be any unit as long as it can convert content handwritten by a user on the display unit and display the data on the display unit. Therefore, the electronic pen is not limited to that using the above-described method. As the method for the electronic pen, it may be possible to use an electromagnetic induction method of obtaining a trajectory of the electronic pen by receiving an induction signal generated because of the electronic pen moving on a magnetic field above a surface of the display unit, an infrared or ultrasonic method in which a sensor on the display unit side senses infrared rays or ultrasound emitted by the electronic pen, an optical method of obtaining a trajectory of the electronic pen blocked by an optical sensor on the display unit side, or a capacitance method of detecting a position according to a difference in the capacitance caused by pressing on the display unit side. Furthermore, the method for the electronic pen may be a method of obtaining position information by making use of the luminous principle of plasma.

The above first exemplary embodiment has described the method in which controller 150 of information processing device 10 and controller 230 of electronic pen 20 communicate using Bluetooth (a registered trademark). It is sufficient that electronic pen 20 can transmit, to information processing device 10, data including position information about contact or proximity, contact information from pen pressure sensor 240, etc. Therefore, the communication method is not limited to Bluetooth (a registered trademark). The communication method may be a wireless LAN or may be a wired universal serial bus (USB) or a wired local area network (LAN). Furthermore, in cases where the position information about contact or proximity of electronic pen 20 can be detected on the information processing device 10 side by the method for the electronic pen, it is not necessary to perform communication between information processing device 10 and electronic pen 20.

Although contact of electronic pen 20 with the screen of liquid-crystal panel 130 is detected in Step S2 in FIG. 7 in order to determine whether or not electronic pen 20 has been operated in the above first exemplary embodiment, proximity of electronic pen 20 to the screen of liquid-crystal panel 130 may be detected instead of detecting contact of electronic pen 20. Specifically, when proximity to the extent that position information of electronic pen 20 can be obtained is detected in Step S2, an event for the on-screen key may be issued.

The above first exemplary embodiment has described, as one example of the operation key, a method using the on-screen key which is a virtual key displayed on liquid-crystal panel 130. The operation key, however, is not limited to the on-screen key and may be an input device (such as a keypad, a keyboard, a mouse, or a pointing device) externally connected to information processing device 10 or embedded in information processing device 10. In this case, key input utility 33 may hook the input to a specific key such as a click button or a middle button of a mouse and issue an event for the specific key on the basis of detection of contact of electronic pen 20 (Steps S2 and S3 in FIG. 7).

The exemplary embodiments have been described above as an exemplification of the techniques of the present disclosure. To this extent, the accompanying drawings and the detailed description are provided.

Thus, the structural elements set forth in the accompanying drawings and the detailed description include not only essential structural elements, but also non-essential structural elements, for exemplifying the techniques described above. As such, these non-essential structural elements should not be deemed essential due to the mere fact that these non-essential structural elements are described in the accompanying drawings and the detailed description.

Furthermore, since the above-described exemplary embodiments are for exemplifying the techniques of the present disclosure, various modifications, substitutions, additions, omissions, etc., can be carried out within the scope of the claims and their equivalents.

### INDUSTRIAL APPLICABILITY

The present disclosure is applicable to electronic devices on which information input using the position indicator and the operation key is possible. Specifically, the present disclosure is applicable to devices such as smartphones, tablets, and electronic whiteboards.

What is claimed is:

1. An information processing device on which information input using a position indicator and an operation key is possible, the information processing device comprising:
a display unit that displays information;
a first detector that detects one of contact and proximity of the position indicator with respect to the display unit;
a second detector that detects an operation of the operation key by a user; and
a controller that issues an event for the operation key the operation of which has been detected by the second detector, wherein
the controller does not issue the event for the operation key in cases where none of the contact and the proximity of the position indicator has been detected when the second detector detects the operation of the operation key, and
subsequently, when one of the contact and the proximity of the position indicator is detected, the controller issues the event for the operation key.

2. The information processing device according to claim 1, wherein
the controller issues the event for the operation key in cases where one of the contact and the proximity of the position indicator has been detected when the second detector detects the operation of the operation key.

3. The information processing device according to claim 1, further comprising
a storage that stores information indicating operating states of a plurality of the operation keys operated in a period between detection of the operation of the operation key and detection of one of the contact and the proximity of the position indicator with respect to the display unit, wherein
when one of the contact and the proximity of the position indicator with respect to the display unit is detected after the detection of the operation of the operation key, the controller issues the event for each of the operating states of the plurality of the operation keys stored in the storage.

4. The information processing device according to claim 1, wherein
the operation key is a key displayed on the display unit.

5. The information processing device according to claim 1, wherein
the position indicator is an electronic pen.

6. An input control method for controlling an input to an information processing device using a position indicator and an operation key, the input control method comprising:
detecting one of contact and proximity of the position indicator with respect to a display unit of the information processing device;
detecting an operation by a user of the operation key; and
issuing an event for the operation key the operation of which has been detected, wherein
in the issuing of the event,
the event for the operation key is not issued in cases where none of the contact and the proximity of the position indicator has been detected when the operation of the operation key is detected, and
subsequently, when one of the contact and the proximity of the position indicator is detected, the event for the operation key is issued.

7. A computer-readable storage medium storing a program for causing an information processing device to perform the input control method according to claim 6.
